(19) United States
(12) Patent Application Publication
(10) Pub. No.: US 2019/0288418 A1
(43) Pub. Date: Sep. 19, 2019

(54) CABLE ASSEMBLY

(71) Applicant: CHENG UEI PRECISION INDUSTRY CO., LTD., New Taipei City (TW)

(72) Inventors: JI-PING ZHONG, Dong-Guan City (CN); JIA-HAO LIU, Dong-Guan City (CN); QING-HONG LIN, Dong-Guan City (CN)

(21) Appl. No.: 16/186,370

(22) Filed: Nov. 9, 2018

(30) Foreign Application Priority Data
Mar. 13, 2018 (CN) 201820340116.3

(51) Int. Cl. H01R 12/53; H01R 12/72; H01R 12/70; H01R 13/6581; H01R 43/02; H01R 43/24

(52) U.S. Cl. CPC H01R 12/53; H01R 12/722; H01R 12/707; H01R 12/57; H01R 43/0256; H01R 43/24; H01R 13/6581

(57) ABSTRACT

The present invention includes a cable having a plurality of conducting wires; a circuit board arranged at a front of the cable, the conducting wires of the cable being soldered at a rear of the circuit board; a connector arranged at a front of the circuit board and having a plurality of terminal slots; a plurality of terminals secured in the terminal slots to connect to the front of the circuit board with its rear end. The circuit board joined between the cable and the connector in this invention is configured to control the resistance, besides it also benefits the soldering of the cable and the contactor and reduces the yield loss due to the solder paste applied in the SMT process; and the requirements of high frequency specifications can also be satisfied by the circuit arranged on the circuit board.

### BACKGROUND OF THE INVENTION

### 1. Field of the Invention

This invention relates to a cable assembly, particularly a high frequency cable assembly.

### 2. The Related Art

The present invention relates to a cable assembly, a cable assembly for high frequency transmission. The US patent 2017/0221604A1 discloses a cable assembly consisted of a cable, a shielding housing, a ground grid, a plurality of contacts and a plug portion to satisfy high definition multimedia interface (HDMI) specification standard. As disclosed in said US patent, the contacts are secured in the plug portion, and the rear end of the contacts are exposed behind the plug portion for connecting with the cable, the ground grid is disposed between the cable and the contactor, the shielding shell surrounds the cable, the plurality of cable and the ground grid and soldered to the ground grid which is configured to reduce the insertion loss during the signal transmission. However, to satisfy the specification standard of HDMI 2.1, the insertion loss and the resistance needs to be controlled. Said ground grid only reduces the insertion loss and can't satisfy the HDMI 2.1 specification standard.

Therefore, it is necessary to provide a cable assembly having appropriate cable components to satisfy the HDMI 2.1 specification standard.

### SUMMARY OF THE INVENTION

The objective of the present invention is to provide a cable assembly for improving the lack and defects in the conventional cable connector.

To achieve said objective, the cable assembly according to an embodiment of the present invention includes a cable having a plurality of conducting wires; a circuit board arranged at a front of the cable, the conducting wires of the cable being soldered at a rear of the circuit board; a connector arranged at a front of the circuit board and having a plurality of terminal slots; a plurality of terminals secured in the terminal slots to connect to the front of the circuit board with its rear end.

In another preferred embodiment, the circuit board includes a front soldering portion arranged at the front of the circuit board, a rear soldering portion arranged at the rear of the circuit board and a circuit arranged on the circuit board.

In another preferred embodiment, the cable assembly further comprising a regularized portion for regularizing and securing the conducting wires to the rear soldering portion of the circuit board.

In another preferred embodiment, the connector includes a plug and a combined structure made up of a first insulation portion and a second insulation portion positioned at a rear of the plug, the plug has a plurality of front terminal slots, a connecting space at a front of the plug and a stop portion extended outward at a rear of the plug.

In another preferred embodiment, a bottom surface of the first insulation portion has a first fixing block extended downward, an upper surface of the second insulation portion has a first fixing notch for mating with the first fixing block, both of the first insulation portion and the second insulation portion has a second fixing block extended outward at an external surface thereof and a plurality of rear terminal slots running through thereof, each of the front terminal slots connects to each of the rear terminal slots to form a complete terminal slot.

In another preferred embodiment, the cable assembly further comprising an iron housing made up of a front iron housing and a rear iron housing, the front iron housing arranged around the plug, the first insulation portion and the second insulation portion, and having a limiting portion extended outward at a rear thereof, a second fixing notch which is mated with the second fixing block disposed at an upper and a bottom surfaces of a rear end of the front iron housing, and a stop block disposed at an internal surface of the front iron housing.

In another preferred embodiment, the cable assembly further comprising an internal housing arranged around an end of the rear iron housing and an external housing arranged around the rear iron housing, the internal housing and the front of the cable.

In another preferred embodiment, the cable assembly comprises a cable having a plurality of conductive wires; a regularized portion molded with the conductive wires; a circuit board having a front soldering portion and a rear soldering portion soldered to the conductive wires; a connector having a plurality of terminals soldered to the front soldering portion of the circuit board; a rear metal housing surrounding the circuit board, the regularized portion and the conductive wires; an internal housing surrounding a rear of the rear metal housing; and a external housing surrounding the internal housing and the rear metal housing.

A method of manufacturing a cable assembly comprising: passing a plurality of wires of a cable through a rear metal housing; molding a regularized portion on the wires; soldering the wires with a rear soldering portion of a circuit board, soldering a plurality of terminals of connector with a front soldering portion of the circuit board; assembling the rear metal housing with the connector to position the rear metal housing to surround the conductive wires, the regularized portion, the circuit board and a rear of the connector; molding an internal housing with a rear of the rear metal housing; and molding an external housing to surround the internal housing and the rear metal housing.

In conclusion, the cable assembly in the percent invention replaces the grounding grid with the circuit board for controlling the resistance with the circuit on the circuit board; besides, the solder paste is applied to the circuit board in advance with SMT (surface mount technology) to reduce the yield loss; and the high frequency performance of the cable assembly in this invention can also be satisfied with the circuit arranged on the circuit board, thus to achieve the specification standard of connectors.

### BRIEF DESCRIPTION OF THE DRAWINGS

The present invention will be apparent to those skilled in the art by reading the following description, with reference to the attached drawings, in which:

FIG. 1 shows a perspective view of a cable assembly in a preferred embodiment;

FIG. 2 shows an exploded view of the cable assembly shown in FIG. 1;

FIG. 3 shows a perspective view of an insulation part and a front iron housing in the present invention;

FIG. 4 shows a partial enlarge view of the cable assembly in the present invention;

FIG. 5 shows a top view of a conducting wire, a circuit board and contactors in the present invention;

FIG. 6 shows a cross-sectional view of a cable in the present invention.

### DETAILED DESCRIPTION OF THE PREFERRED EMBODIMENT

In order to describe the technical contents, structural features, purpose to be achieved and the effectiveness of the present invention, the detailed description is given with schema below.

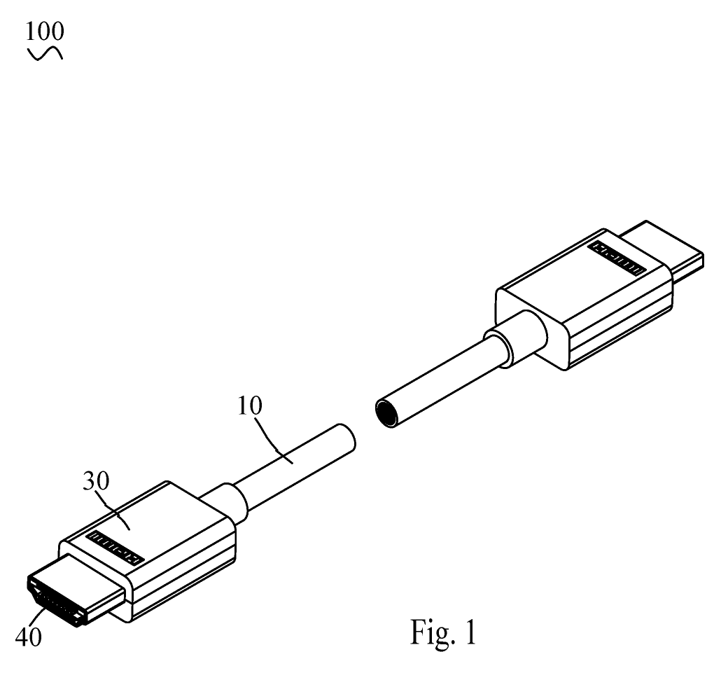

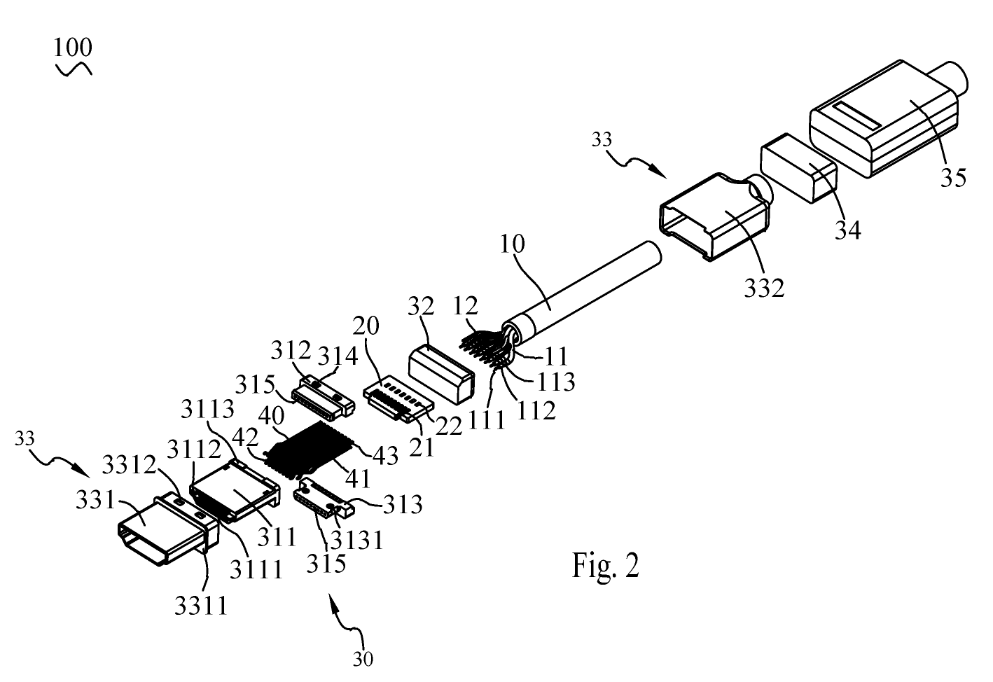

Referring to FIG. 1 and FIG. 2, the cable assembly 100 in the present invention includes a cable 10, a circuit board 20, a connector 30 and a plurality of terminals 40. In a preferred embodiment, the cable assembly 100 satisfies the specification standard of HDMI 2.1 and the connector 30 is a HDMI connector.

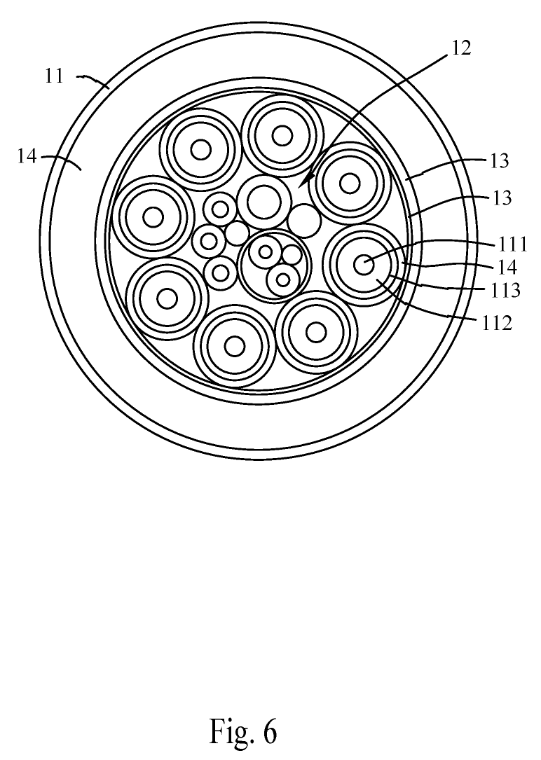

Referring to FIG. 6, the cable 10 includes a plurality of conducting wires 11, the conducting wires 11 are arranged to form a hollow tube inside of the cable 10, each of the conducting wires 11 is a micro-coaxial wire comprising a signal core 111 consisted of a plurality of wires, an insulation layer 112 arranged around the signal core 111, and a shielding layer 113 made of aluminum or copper polyester film and arranged around the insulation layer 112. The insulation layer 112 protrudes from the shielding layer 113, and the signal core 11 protrudes from the insulation layer 112.

A plurality of central wires 12 are disposed within the hollow tube and surrounded by said conducting wires 11, and the central wires 12 comprise a power supply wire, a grounding wire and other wires for HDMI or other use. Two layers of polyester tapes 13 is bound around the conducting wires 11 and a jacket 14 is arranged around the two layers of the polyester tapes 13.

Referring to FIG. 2, the circuit board 20 is connected at a front of the cable 10 and a rear of the connector 30. The circuit board 20 has a front soldering portion 21 and a rear soldering portion 22. The conducting wires 11 of the cable 10 are soldered to the rear soldering portion 22. The circuit board 20 further comprises a circuit (not shown). The cables 10 in this embodiment are separated into two rows and being soldered to an upper and a bottom surfaces of the rear soldering portion 22 respectively.

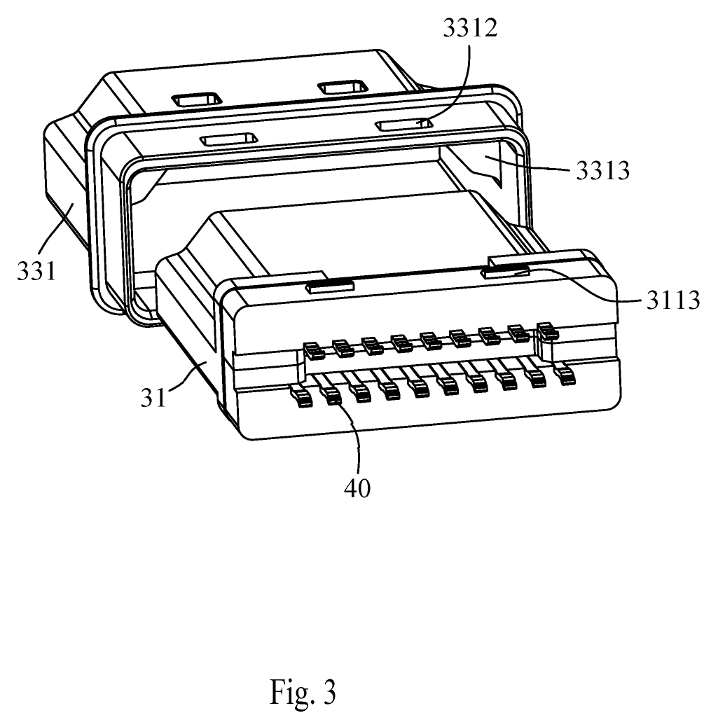

Referring to the FIG. 2 to FIG. 4, the connector 30 is arranged at a front of the circuit board 20 and has an insulation part 31 consisted of a plug 311 and a combined structure made up of a second insulation portion 313 and a first insulation portion 312 mated on a top of the second insulation portion 313. The plug 311 is positioned at a front of the first insulation portion 312 and the second insulation portion 313. The plug 311 comprises a plurality of front terminal slots 3111 extended through the plug 311, a connecting space 3112 is formed at a front of the plug 311 to connect with a mating connector (not shown). A stop portion 3113 is extended outward from a rear of the plug 311. A bottom surface of the first insulation portion 312 having a first fixing block 3121 extended downward, and an upper surface of the second insulation portion having a first fixing notch 3131 to mate with the first fixing block 3121 for jointing the first insulation portion 312 and the second insulation portion 313 together. Both external surfaces of the first insulation portion 312 and the second insulation portion 313 has a second fixing block 314 extended outward, and both the first insulation portion 312 and the second insulation portion 313 has a plurality of rear terminal slots 315 extended through the plug 311 for connecting with the front terminal slots 3111 respectively to form a plurality of complete terminal slots which is extended through the plug 311.

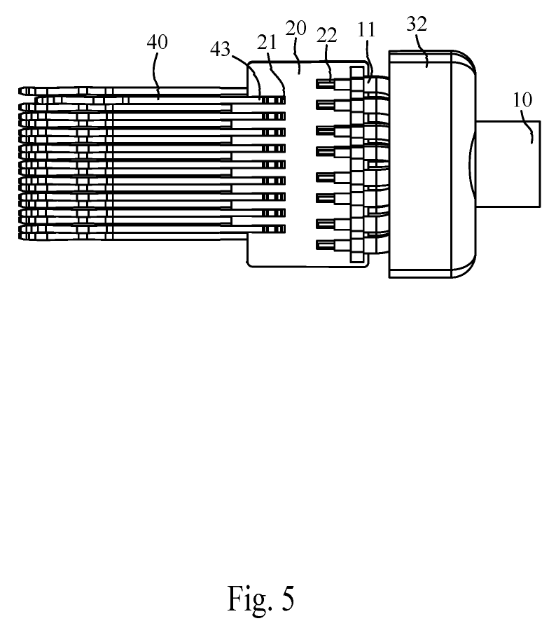

Referring to FIG. 2 and FIG. 5 now, the cable 10 having a regularized portion 32 for regularizing the conducting wires 11 and aligning the conducting wire 11 with soldering spots on the circuit board 20. The cable assembly 100 further comprises an iron housing 33 which is consisted of a front iron housing 331 and a rear iron housing 332. The front iron housing 331 surrounds the insulation part 31 and has a limiting portion 3311 extended outward from a rear of the front iron housing 331. Both an upper and a bottom surfaces of a rear end of the front iron housing 331 having a second fixing notch 3312 for mating with the second fixing block 314, a stop block 3313 is arranged on an inner surface of the front iron housing 331. The rear iron housing 332 surrounds the rear of the front iron housing 331, the circuit board 30 and the regularized portion 32 for covering the front of the cable 10. The cable assembly 100 includes an internal housing 34 surrounding a rear of the rear iron housing 332, and the cable assembly 100 includes an external housing 35 surrounding the rear iron housing 332, the internal housing 34 and the front of the cable 10.

Referring to FIG. 2 now, each of the terminals 40 includes a fixing portion 41, a connecting portion 42 extending from a front of the fixing portion 41 and a welding portion 43 extending from a rear of the fixing portion 41. The fixing portion 41 is secured in the terminal slot to expose the connecting portion 42 out of the connecting space 313 and the welding portion 43 out of a rear of the insulation part 31 for soldering to the front soldering portion 21.

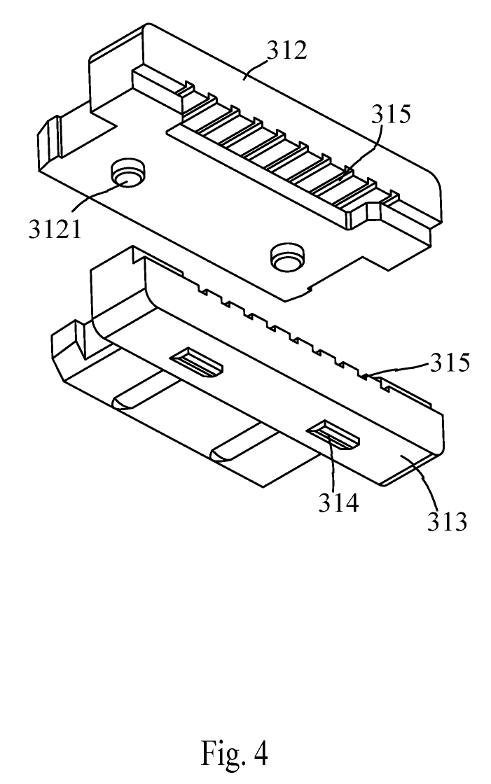

Referring to FIG. 2 and FIG. 4, while assembling the cable assembly 100 according to the present invention, the cable 10 is passed through the rear iron housing 332 first, then the plurality of the conducting wires 11 are sorted into a row and the plurality of the central wires 12 into another row. Then the regularized portion 32 is molded on the two rows of the wires 11, 12 to fix said wires 11, 12 into two rows.

Referring to FIG. 2 to FIG. 4, the terminals 40 are sorted into an upper row and a lower row. The upper row of the terminals 40 is molded with the first insulation portion 312 and the lower row of the terminals 40 is molded with the second insulation portion 313. The first insulation portion 312 and the second insulation portion 313 are mated together by the first fixing block 3121 and the first fixing notch 3131. Then The first insulation portion 312 with the upper row of the terminals and the second insulation portion 313 with the lower row of the terminals are inserted into the plug 311 from the rear of the plug 30. The terminals 40 are received in the front terminal slots 3111 and the rear terminal slots 315. The fixing portion 41 of each of the terminals 40 is secured in each of the complete terminal slots, the connecting portion 42 of each of the terminals 40 is extended through each of the front terminal slots 3111 to be exposed out of the connecting space 313, the welding portion 43 of each of the terminals 40 are extended through each of the rear terminal slots 315. The circuit board 20 is soldered to the welding portions 43 at the rear of the connector 30 to secure the circuit board 20 at the rear of the connector 30.

The front soldering portion 21 on the both sides of the circuit board 20 are then applied with solder paste for soldering to the welding portions 43. The rear soldering portion 22 on both sides of the circuit board 20 are then applied with solder paste for soldering to the plurality of the conducting wires 11 and the plurality of the central wires 12, thus the cable 10 is soldered to the rear of the circuit board 20, and the shielding layer 113 is electronically connected to a ground of the circuit board 20 for grounding.

The front iron housing 331 is arranged around the plug 311, the second fixing block 314 of the first insulation portion 312 and the second insulation portion 313 are positioned into the second fixing notch 3312 of the front iron housing 331 to fasten the front iron housing 331 on the plug 311. Next, a front surface of the rear iron housing 332 is mated with a rear surface of the limiting portion 3311 of the front iron housing 331 and soldered together. The internal housing 34 is formed at a rear of the rear iron housing 332, the external housing 35 is formed around the rear iron housing 332, the internal housing 34 and the front of the cable 10 to complete the assemble of the cable assembly 100.

In the embodiment according to this invention, the conducting wires 11 and the central wires 12 of the cable 10 are lined up into two rows and being soldered on two surfaces of the circuit board 20 respectively, by which the conducting wire 11 and the central wire 12 can be peeling easily with laser, thus saves lots of assembling time and reduces the yield loss.

Besides, the front iron housing 331 and the rear iron housing 332 are made with deep drawing process, and the iron housing 33 can shield EMI (electromagnetic interference) and reduce the interference of noises.

Moreover, the internal housing 34 and the external housing 35 is made of insulation material to protect the connector 30 from external influence, the internal housing 34 is arranged to ensure the external housing 35 be able to take shape and prevent it from distorted during molding.

In conclusion, the cable assembly 100 in this invention replaces the ground grid with the circuit board 20 to control the resistance. Meanwhile, the circuit board 20 is pasted during the SMT process for soldering with the cable 10 and the terminals 40 to reduce the yield loss rate. The circuit board 20 in the cable assembly 100 has better high frequency response due to the circuit arranged on the circuit board 30 and thus satisfy the connector specification standard.

What is claimed is:

1. A cable assembly comprising:
a cable having a plurality of conducting wires;
a circuit board arranged at a front of the cable, the conducting wires of the cable being soldered at a rear of the circuit board;
a connector arranged at a front of the circuit board and having a plurality of terminal slots; and
a plurality of terminals secured in the terminal slots to connect to the front of the circuit board with its rear end.

2. The cable assembly as claimed in claim 1, wherein the circuit board includes a front soldering portion arranged at the front of the circuit board, a rear soldering portion arranged at the rear of the circuit board and a circuit arranged on the circuit board.

3. The cable assembly as claimed in claim 1, further comprising a regularized portion for regularizing and securing the conducting wires to the rear soldering portion of the circuit board.

4. The cable assembly as claimed in claim 1, wherein the connector includes a plug and a combined structure made up of a first insulation portion and a second insulation portion positioned at a rear of the plug, the plug has a plurality of front terminal slots, a connecting space at a front of the plug and a stop portion extended outward at a rear of the plug.

5. The cable assembly as claimed in claim 4, wherein a bottom surface of the first insulation portion has a first fixing block extended downward, an upper surface of the second insulation portion has a first fixing notch for mating with the first fixing block, both of the first insulation portion and the second insulation portion has a second fixing block extended outward at an external surface thereof and a plurality of rear terminal slots running through thereof, each of the front terminal slots connects to each of the rear terminal slots to form a complete terminal slot.

6. The cable assembly as claimed in claim 5, further comprising an iron housing made up of a front iron housing and a rear iron housing, the front iron housing arranged around the plug, the first insulation portion and the second insulation portion, and having a limiting portion extended outward at a rear thereof, a second fixing notch which is mated with the second fixing block disposed at an upper and a bottom surfaces of a rear end of the front iron housing, and a stop block disposed at an internal surface of the front iron housing.

7. The cable assembly as claimed in claim 6, further comprising an internal housing arranged around an end of the rear iron housing and an external housing arranged around the rear iron housing, the internal housing and the front of the cable.

8. A cable assembly comprising:
a cable having a plurality of conductive wires;
a regularized portion molded with the conductive wires;
a circuit board having a front soldering portion and a rear soldering portion soldered to the conductive wires;
a connector having a plurality of terminals soldered to the front soldering portion of the circuit board;
a rear metal housing surrounding the circuit board, the regularized portion and the conductive wires;
an internal housing surrounding a rear of the rear metal housing; and
an external housing surrounding the internal housing and the rear metal housing.

9. A method of manufacturing a cable assembly comprising:
passing a plurality of wires of a cable through a rear metal housing;
molding a regularized portion on the wires;
soldering the wires with a rear soldering portion of a circuit board, soldering a plurality of terminals of connector with a front soldering portion of the circuit board;
assembling the rear metal housing with the connector to position the rear metal housing to surround the conductive wires, the regularized portion, the circuit board and a rear of the connector;
molding an internal housing with a rear of the rear metal housing; and
molding an external housing to surround the internal housing and the rear metal housing.
